(19) United States
(12) Patent Application Publication
(10) Pub. No.: US 2008/0054594 A1
(43) Pub. Date: Mar. 6, 2008

(54) AERODYNAMIC BICYCLE FRAME WITH SUBSTITUTED ARCUATE SEAT TUBE

(76) Inventor: Xabier Irizar, Ordizia (ES)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/771,386

(22) Filed: Jun. 29, 2007

Related U.S. Application Data
(60) Provisional application No. 60/818,151, filed on Jul. 1, 2006.

(51) Int. Cl. B62K 3/04

(52) U.S. Cl. 280/281.1

(57) ABSTRACT

An aerodynamic bicycle frame is described. In one embodiment, the aerodynamic bicycle frame comprises a head tube; a top tube, a first end of the top tube being connected with the head tube; a down tube, a first end of the down tube being connected with the head tube; a pair of seat stays connected with a second end of the top tube; and a one-part arcuate tube joining an upper region of the pair of seat stays and a second end of the down tube, the one-part arcuate tube being curved longitudinally toward the head tube so as to conform to a curvature of a rear bicycle wheel, the one-part arcuate tube shielding an angular section of the rear bicycle wheel from aerodynamic turbulence to reduce the net aerodynamic drag on the frame.

### PRIORITY

The present application claims priority from commonly owned and assigned U.S. Provisional Application No. 60/818,151, Attorney Docket No. ORBE-001/00US, entitled “Aerodynamic Bicycle Frame with Substituted Arcuate Seat Tube,” which is incorporated herein by reference in its entirety.

### FIELD OF THE INVENTION

The present invention relates generally to the field of bicycles and bicycle frames. More specifically, the present invention relates, without limitation, to aerodynamic bicycle frames used for road racing, time trialing, triathlon, and related sporting events where speed is a premium.

### BACKGROUND OF THE INVENTION

In the competitive worlds of professional road bicycle racing and triathlon, success is often determined by a matter of seconds. To aid competitive athletes, the trend in innovative bicycle frame designs has therefore been increasingly to reduce the aerodynamic drag, (or simply “drag” hereinafter), of both the rider and the frame itself.

As a starting point, the conventional double-diamond bicycle frame, as illustrated for example in FIG. 1, is customarily used as a baseline for comparing the drag of different frame designs. Notably, the seat tube consists of a single member affixed at both ends to the bottom bracket and the seat-post junction, respectively. Such designs have been the mainstay of the cycling industry for the majority of the past century and are very widely known in the prior art.

One key manner in which to reduce drag on a bicycle frame is to shield the rear wheel using a frame element, such as the seat tube, so as to cut down on the air turbulence generated when the front-facing upper portion of the rear wheel rotates into the oppositely directed airflow generated by the bicycle's direction of travel. For example, U.S. Pat. No. 5,975,473 to Lawwill and U.S. Pat. No. 4,900,050 to Bishop et al. use a one-piece seat tube with a curved carve-out near the surface of the rear wheel to achieve said shielding. Trimble in U.S. Pat. Nos. Re 33,295; 4,941,674; and 4,982,975 discloses a bicycle frame that comprises a seat tube having a curved section that is cut into a one-piece straight seat tube. Vroomen et al. disclose in U.S. Pat. No. 6,889,992 a two-part seat tube with a straight, substantially vertical upper portion and a curved lower portion that conforms to the rear wheel. None of these designs, however, achieves maximal shielding of the rear wheel.

Although present devices are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

In one embodiment, a bicycle frame shields the largest possible angular section of the rear wheel from aerodynamic turbulence, reduces the net aerodynamic drag on the frame, and otherwise increases the competitive performance of the bicycle. In this embodiment, the bicycle frame comprises a head tube; a top tube, a first end of the top tube being connected with the head tube; a down tube, a first end of the down tube being connected with the head tube; a pair of seat stays connected with a second end of the top tube; and a one-part arcuate tube joining an upper region of the pair of seat stays and a second end of the down tube, the one-part arcuate tube being curved longitudinally toward the head tube so as to conform to a curvature of a rear bicycle wheel, the one-part arcuate tube shielding an angular section of the rear bicycle wheel from aerodynamic turbulence to reduce the net aerodynamic drag on the frame.

Additionally, one or more of the above-described tubes is aerodynamically shaped in some embodiments. Moreover, in an illustrative embodiment, the bicycle frame may be constructed from aluminum, steel, carbon fiber, titanium, or some combination of these materials. If carbon fiber is the chosen material, the carbon fibers can be arranged so as to maximize competitive performance of the bicycle frame, typically by providing the rider with maximum shock absorption while maintaining the stiffness of the frame in the direction of travel when the frame is being ridden.

These and other illustrative embodiments are discussed in further detail herein.

### BRIEF DESCRIPTION OF THE DRAWINGS

Various objects and advantages and a more complete understanding of embodiments of the present invention are described in the following Detailed Description and the appended claims when taken in conjunction with the accompanying Drawings, wherein:

FIG. 1 is a side-view drawing of a double-diamond bicycle;

FIGS. 2(a) and 2(b) are a side-view drawings of a bicycle frame that employs a straight seat tube with a curved carve-out;

FIG. 3 is a side-view drawing of a bicycle frame that incorporates a two-part seat tube comprising a straight upper portion and a curved lower portion conforming to the rear wheel;

FIG. 4 is a side-view drawing of a bicycle frame illustrating a substituted arcuate seat tube joining the bottom bracket to the upper portion of the seatstays near the monostay junction in accordance with an illustrative embodiment of the invention;

FIG. 5 is a top-view drawing of a bicycle frame in accordance with an illustrative embodiment of the invention;

FIG. 6 is a bottom-view drawing of a bicycle frame in accordance with an illustrative embodiment of the invention;

FIG. 7 is a front-view drawing of a bicycle frame in accordance with an illustrative embodiment of the invention;

FIG. 8 is a rear-view drawing of a bicycle frame in accordance with an illustrative embodiment of the invention; and

FIGS. 9(a)-9(c) are cross-sectional views of an arcuate tube connecting a bottom bracket of a bicycle frame to the seat stays in various illustrative embodiments of the invention.

### DETAILED DESCRIPTION

In an illustrative embodiment of the invention, a bicycle frame optimizes the reduction of aerodynamic drag by providing aerodynamic shielding of the rear wheel using frame elements. Specifically, in this illustrative embodiment, the standard straight seat tube connecting the bottom bracket with the top tube just below the seat junction is replaced with an arcuate tube connecting the bottom bracket to the upper portion of the rear seat stays near the monostay junction.

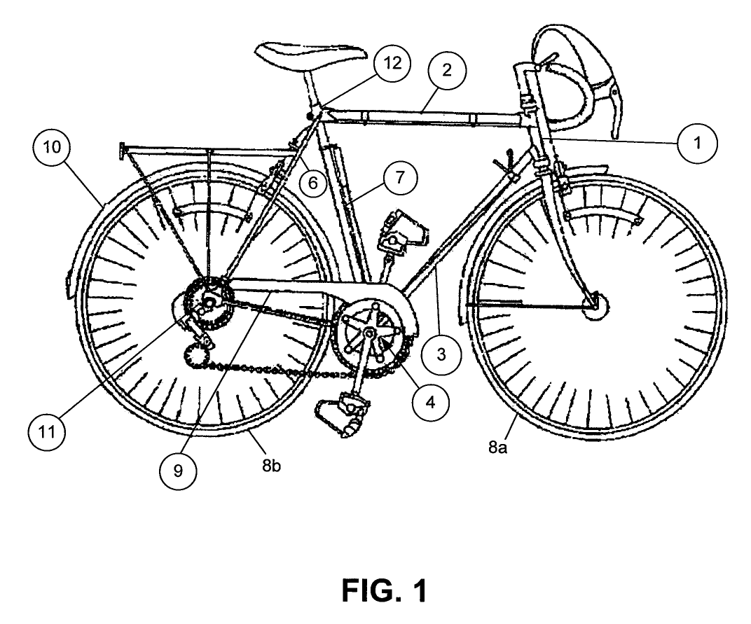

FIG. 1 illustrates a standard double-diamond bicycle. The upper region of head tube 1 connects to top tube 2, which in turn extends transversely in a given direction. The lower region of head tube 1 connects to down tube 3, which also extends transversely and downwardly in the same direction as top tube 2 (i.e., within the plane defined by the bicycle frame). The opposite ends of top tube 2 and down tube 3 are then connected by seat tube 7, thus forming the first diamond of the double-diamond configuration. (Note, however, that short head tube 1, in fact, clips the first diamond, technically forming a parallelogram instead of a true diamond.)

A first set of parallel tubes, called seat stays 6, connects at the seat-tube junction 12, which is the same location where top tube 2 connects with the top end of seat tube 7. Seat stays 6 extend transversely and downwardly in the same direction (same plane) as top tube 2. A second pair of parallel tubes, called chain stays 9, connects at the bottom bracket, which is the same location where the down tube 3 connects with the bottom end of seat tube 7. Chain stays 9 extend transversely in the same direction as top tube 2, the far ends of which connects with the corresponding far ends of seat stays 6 at the hub 11 of the rear wheel 8(b). The second diamond of the double-diamond geometry is thus formed by the seat tube 7, the seat stays 6, and the chain stays 9.

While the double-diamond bicycle frame described immediately above has been a standard configuration in the cycling industry, it has one notable disadvantage: air turbulence tends to form in the gap between the seat tube 7 and the outer radius of rear wheel 8(b). This disadvantage is particularly troublesome since the rear wheel 8(b) is traveling in a forward direction in the region near the gap between the rear wheel 8(b) and the seat tube 7. As such, air turbulence is increased, since the rear wheel 8(b) throws air into the airflow generated by the traveling motion of the bicycle generally, which is directed oppositely to the direction of the rear wheel 8(b) in this region.

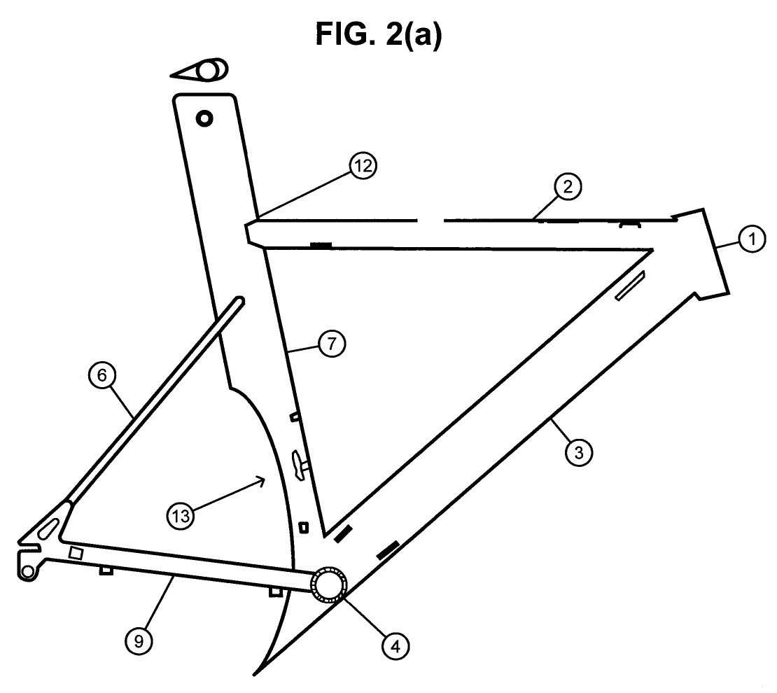

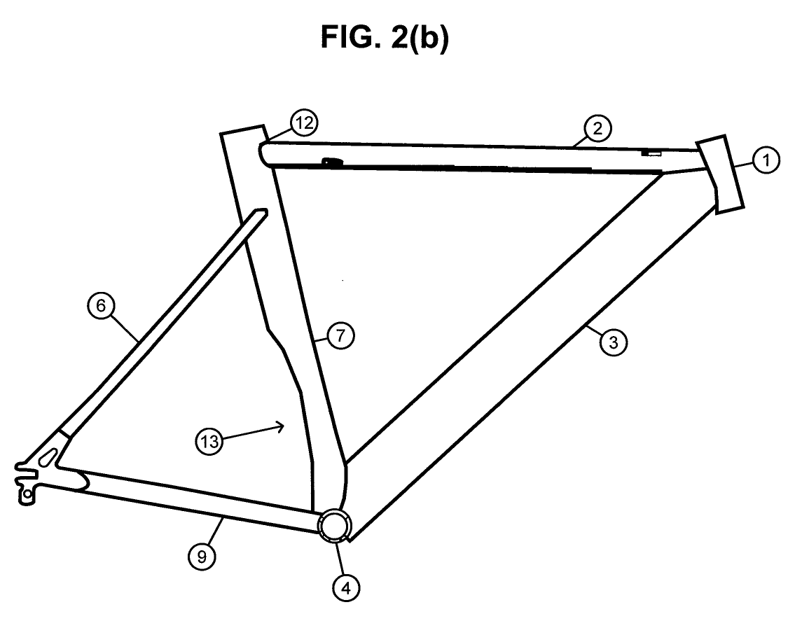

To address this disadvantage, other designs have been introduced. FIGS. 2(a) and 2(b) illustrate two such examples. FIGS. 2(a) and 2(b) illustrate a seat tube 7 that contains a curved carve out 13 in the region where the rear wheel 8(b) comes into close proximity therewith. The seat tube 7 of FIG. 2(a) differs from the seat tube 7 of FIG. 2(b) only in the degree to which the angular section of the rear wheel is shielded. Empirical studies have indicated that increased shielding of the rear wheel leads to reduced aerodynamic drag on the frame.

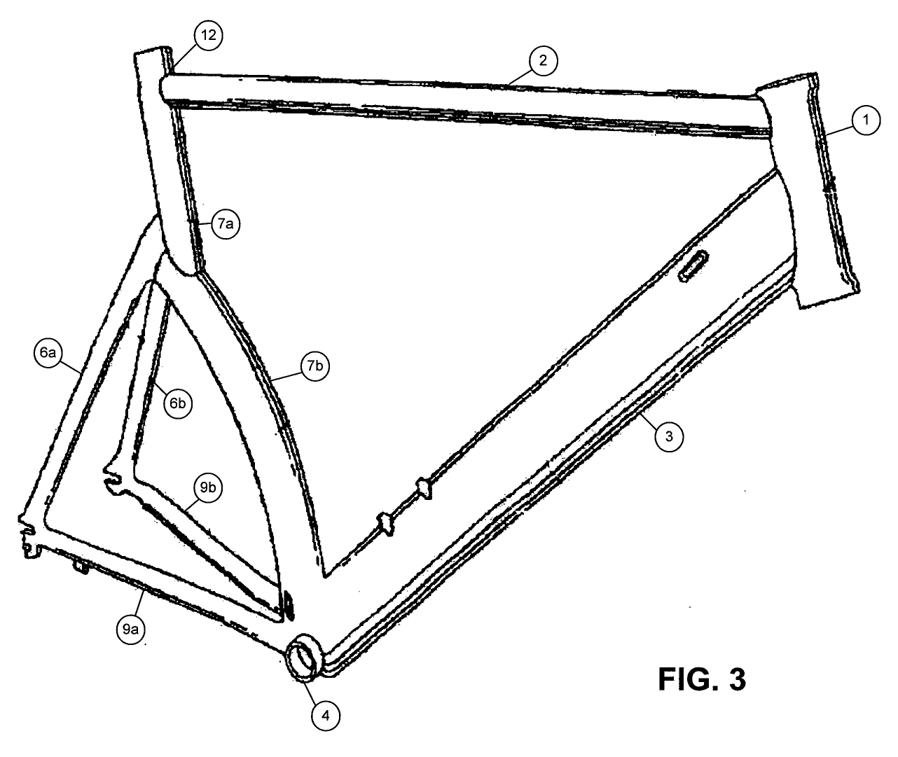

FIG. 3 is a side view drawing of a bicycle frame that incorporates a two-part seat tube 7 comprising a straight upper 7(a) portion, and a curved lower portion 7(b) conforming to the rear wheel. The curved lower portion 7(b) provides the most shielding of any frame known in the prior art. Additional shielding, however, is possible by virtue of the present invention.

FIG. 4 provides a side-view illustration of a bicycle frame made in accordance with an illustrative embodiment of the invention, in which a substituted arcuate tube 14 replaces the seat tube 7 (see FIG. 1). Arcuate tube 14 connects the bottom bracket 15 with the upper region of the seat stays 16, instead of with the far end of top tube 17. As such, a small region of the seat stays 16 extends transversely and downwardly from the seat-post junction 18 before the junction of the arcuate tube 14 and seat stays 16. The arcuate tube 14 curves to the radius of the rear wheel 19, such that only a small gap occurs between the outer radius of the rear wheel 19 and the rear side of the arcuate tube 14. This small gap prevents the creation and accumulation of air turbulence in this critical region. Additionally, since the arcuate tube 14 remains curved throughout its length, and since it connects to other frame elements at the upper portion of the seat stays 16, it provides a larger angular region of shielding to the rear wheel 19 than any frame known in the prior art.

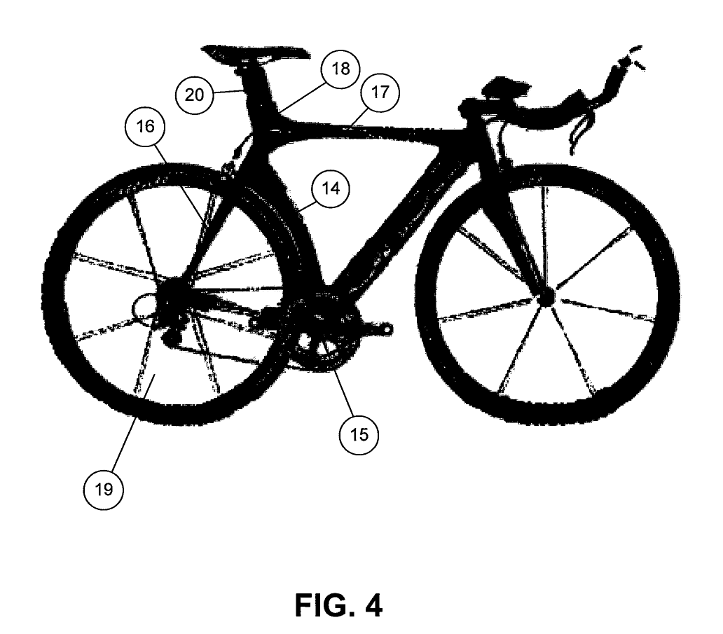

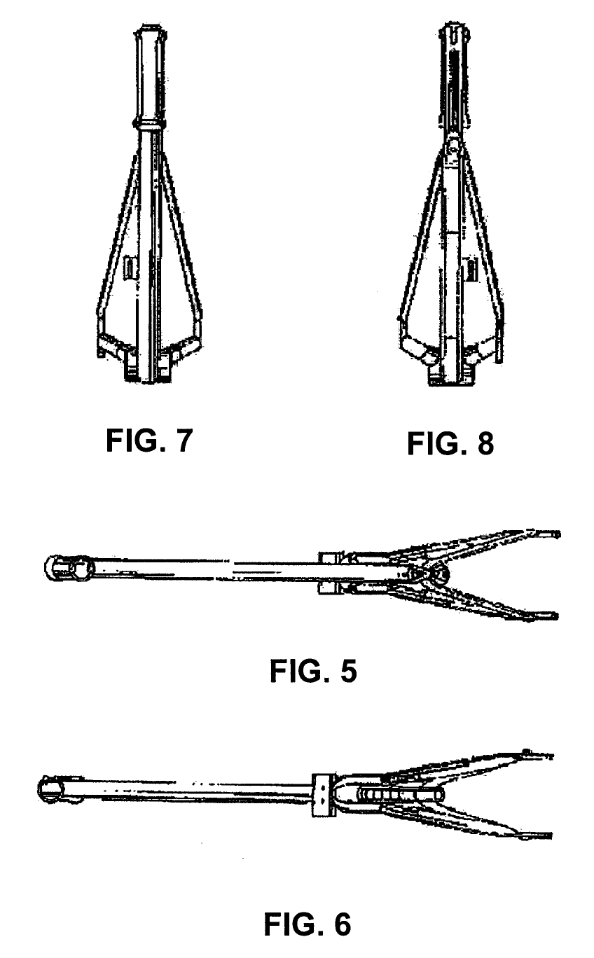

FIG. 5 illustrates a top view of a bicycle frame in accordance with an illustrative embodiment of the invention.

FIG. 6 illustrates a bottom view of a bicycle frame in accordance with an illustrative embodiment of the invention.

FIG. 7 illustrates a front view of a bicycle frame in accordance with an illustrative embodiment of the invention.

FIG. 8 illustrates a rear view of a bicycle frame in accordance with an illustrative embodiment of the invention.

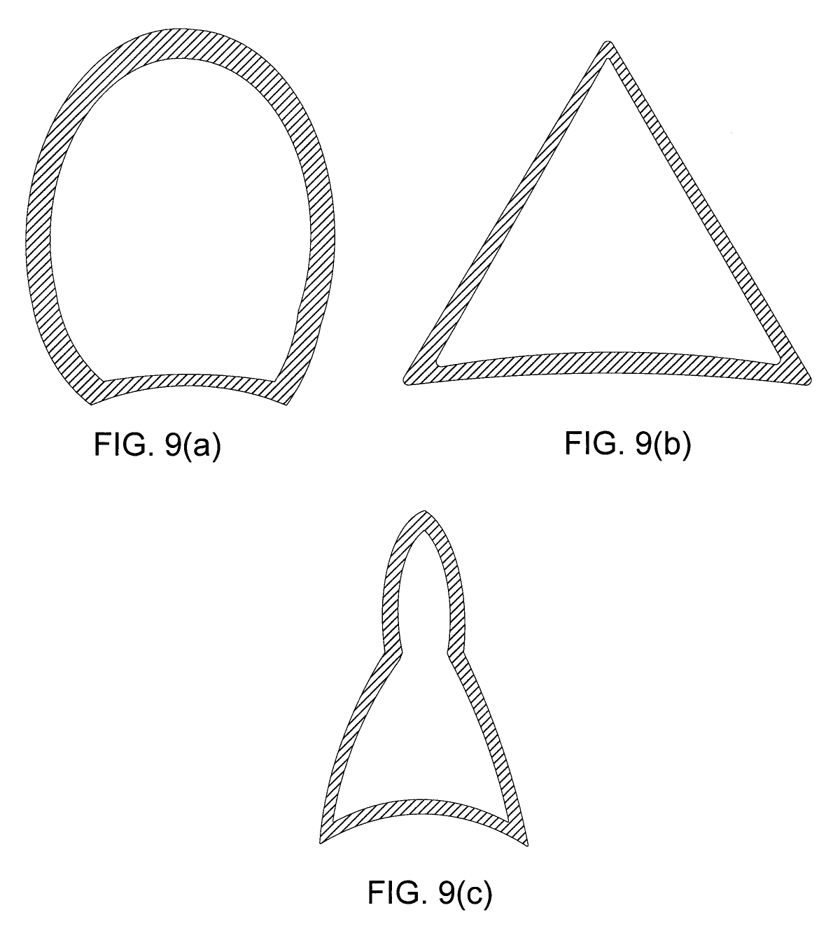

FIGS. 9(a)-9(c) are cross-sectional views of the arcuate tube 14 connecting the bottom bracket to the seat stays in various illustrative embodiments of the invention.

In one embodiment, the arcuate tube 14 is aero shaped so as to provide the least amount of air resistance to its front cross section. In another embodiment, the rear side of the arcuate tube 14 is curved longitudinally, as well as transversely, so as to conform to the longitudinal curvature of the rear wheel (see FIGS. 9(a)-9(c)). As such, by its cross section, arcuate tube 14 acts as a fairing to further reduce air resistance around the rear wheel 19.

In another embodiment, the junction 18 between the top tube 17 and the seat stays 16 is adapted so as to receive a seat post member 20. Seat post member 20 is preferably aero shaped so as to provide the least amount of air resistance to its front cross section. Seat post member 20 may be substantially vertical or oriented at an angle to the vertical, either forward or rearward, to any degree desirable for specific performance needs. Additionally, in another embodiment, seat post member 20 may have a cross-sectional shape such that it may be inserted into the receiving means located at the junction of top tube 17 and seat stays 16 in either a forward sloping or rearward sloping direction, depending upon the orientation of the seat post member 20. In this manner, the position of the rider may be altered on the frame by simply switching the seat post member 20.

In one embodiment of the present invention, the bicycle frame is constructed of high-modulus (hardened) carbon fibers, oriented so as to provide an optimal mix of longitudinal rigidity and lateral flexibility, thereby maximizing both stiffness and efficiency in the direction of travel and rider comfort. In another preferred embodiment of the present invention, the bicycle frame meets the latest regulations promulgated by UCI (Union Cycliste Internationale), the international body governing the sport of competitive cycling, USAT (U.S.A. Triathlon), the national body governing the sport of competitive triathlon, or other relevant governing bodies, regarding the weight, rigidity, and strength of bicycles or bicycle frames. Additionally, in other embodiments of the invention, any other suitable material can be used to construction the bicycle frame, including, but not limited to, aluminum, steel, titanium, thermoplastics, or other material that provides desirable combinations of strength, rigidity, and light weight.

In conclusion, the present invention provides, among other things, an aerodynamic bicycle frame. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A bicycle frame, comprising:
a head tube;
a top tube, a first end of the top tube being connected with the head tube;
a down tube, a first end of the down tube being connected with the head tube;
a pair of seat stays connected with a second end of the top tube; and
a one-part arcuate tube joining an upper region of the pair of seat stays and a second end of the down tube, the one-part arcuate tube being curved longitudinally toward the head tube so as to conform to a curvature of a rear bicycle wheel, the one-part arcuate tube shielding an angular section of the rear bicycle wheel from aerodynamic turbulence to reduce the net aerodynamic drag on the frame.

2. The bicycle frame of claim 1, wherein the bicycle frame is made of steel, aluminum, or titanium.

3. The bicycle frame of claim 1, wherein the bicycle frame is made of hardened carbon fibers.

4. The bicycle frame of claim 3, wherein the hardened carbon fibers are arranged so as to achieve a predetermined desired longitudinal rigidity and lateral flexibility, thereby maximizing stiffness and efficiency in a direction of travel and rider comfort.

5. The bicycle frame of claim 3, wherein the hardened carbon fibers are arranged so as to provide shock absorption to a rider of the bicycle frame while maintaining rigidity in a direction of travel while the bicycle frame is being ridden.

6. The bicycle frame of claim 1, wherein the head tube is aerodynamically shaped.

7. The bicycle frame of claim 1, wherein the top tube is aerodynamically shaped.

8. The bicycle frame of claim 1, wherein the down tube is aerodynamically shaped.

9. The bicycle frame of claim 1, wherein each of the pair of seat stays is aerodynamically shaped.

10. The bicycle frame of claim 1, wherein the one-part arcuate tube is aerodynamically shaped.

11. The bicycle frame of claim 1, further comprising:
a pair of chain stays attached at their first ends to a lower region of the one-part arcuate tube, the pair of chain stays being attached at their second ends to a hub at a center of the rear bicycle wheel.

12. The bicycle frame of claim 11, wherein each of the pair of chain stays is aerodynamically shaped.

13. The bicycle frame of claim 11, wherein the pair of seat stays are substantially parallel tubes and the pair of chain stays are substantially parallel tubes.

14. The bicycle frame of claim 1, wherein the one-part arcuate tube is transversely curved in both horizontal and vertical planes.
